(19) United States
(12) Patent Application Publication
(10) Pub. No.: US 2009/0034369 A1
(43) Pub. Date: Feb. 5, 2009

(54) Direct current ultrasonic pest deterrent system

(76) Inventor: Michael C. Hill, Durango, CO (US)

Correspondence Address: Michael C. Hill, P.O. Box 3699, Durango, CO, 81302, US

(21) Appl. No.: 12/220,159

(22) Filed: Jul. 22, 2008

Related U.S. Application Data
(60) Provisional application No. 60/963,660, filed on Aug. 3, 2007.

(51) Int. Cl. H04B 1/02

(52) U.S. Cl. 367/139

(57) ABSTRACT

An ultrasonic pest deterrent system is described. An embodiment of the present invention produces ultrasonic sound waves using a direct current power source and can vary the frequency of the generated sound waves. Deterrence can be further enhanced by varying the timing and intensity of the sounds as well. The system can be hard-wired to a D/C power source such as a car battery or it can connect via a removable attachment such as a cigarette lighter plug. Remote operation is contemplated.

### CROSS-REFERENCE TO RELATED APPLICATIONS

This application claims benefit of U.S. Provisional Application No. 60/963,660, entitled “Ultrasonic Pest Deterrent System” and filed on Aug. 3, 2007, which is specifically incorporated herein by reference for all that it discloses and teaches.

### TECHNICAL FIELD

The invention relates generally to pest deterrent systems, and more particularly to ultrasonic pest deterrent systems utilizing multiple ultrasonic frequencies.

### BACKGROUND

It is well known that rodents, including rats, mice, chipmunks and squirrels, among others, can be particularly troublesome pests when they live in close proximity to humans. This is especially true when a rodent attempts to nest in a garage, house, vehicle, engine compartment, shed, airplane, recreational vehicle, hot tub mechanical system, agricultural equipment, etc. During nest-building, rodents often chew on wiring and other valuables and can cause a large amount of damage in very little time. Furthermore, rodent wastes can quickly become overpowering and can be extremely difficult to purge. Besides the obvious mess and destruction a nesting rodent can cause, the nests themselves are also home to a number of viruses and diseases commonly associated with rodents such as the Black Plague, Hantavirus, Salmonella, Leptospirosis or Weil's disease, Rickettsial pox, Meningitis, and Dermatitis, among others.

Clearly, there is a need to deter rodents from nesting, feeding, or otherwise entering areas that would put them in close proximity to humans. For centuries, humans have been using traps, poisons, predators, etc. to attempt to control rodent populations, with varying degrees of success. Recently, it has been found that rodents are adversely affected by ultrasonic or high-frequency sound waves. The frequencies of such sound waves cover a wide range but are generally above the audible range for humans and domestic animals, i.e., above twenty kilohertz.

There are many theories as to the reasons why ultrasonic sound waves are deleterious to rodents. One theory is that the high-frequency sound waves are similar in frequency to rodent communication sounds. The effect on rodents of deterrent systems employing ultrasonic sound waves has been likened to that of one human continuously yelling at another human. The noise levels required to sufficiently degrade the livability of environments for rodents can be as low as a few decibels to well over 100 dB.

In addition to rodents, other animals, birds and insects can cause trouble by making homes or otherwise entering areas in close proximity to humans. Fortunately, ultrasonic sound can be used to deter such behavior.

Ultrasonic pest deterrent devices are currently known in the art and are available for limited applications. Illustrative of such devices are those disclosed in U.S. Pat. Nos. 2,922,999; 3,138,138; 3,188,999; 3,277,861; 3,522,791; and 4,284,845, the contents of which are incorporated by reference herein. Specifically, systems which plug-in to standard 120 volt alternating current (A/C) wall outlets are available for protecting a house or garage from infestation by rodents. The first limitation of such systems is that they are incapable of plugging into a 12 volt direct current (D/C) power source. Thus, there are many locations including inside or near cars, trucks, RVs, boats, airplanes, agricultural equipment, hot tubs, solar homes, or any other device that operates on a D/C power system in which existing ultrasonic deterrent systems can not be used. Furthermore, existing systems often emit limited-frequency sound waves that do not deter a wide range of species. Also, many such systems do not vary the output characteristics of the sound waves, thereby allowing rodents to grow accustomed to the sound waves and ultimately decreasing the long-term effectiveness of such systems. Of the patents listed above, none disclose or suggest a 12 volt D/C ultrasonic pest deterrent sound wave generating device utilizing multiple, varying ultrasonic frequencies that are designed to vary in frequency, intensity and duration.

There is therefore a need for a 12 volt D/C ultrasonic pest deterrent system utilizing multiple, varying ultrasonic frequencies.

### SUMMARY

Embodiments of the present invention described and claimed herein address the foregoing problems by application of one or more systems that enable ultrasonic sound waves to be generated using a D/C system that can vary timing, intensity, and/or frequency of the generated sound waves.

Various embodiments are described and recited herein. Although materials and methods similar or equivalent to those described herein can be used in the practice of the invention, suitable materials and methods are described below. Furthermore, the materials, methods, and examples are illustrative and not intended to be limiting.

In one embodiment, a housing contains many of the components of a D/C ultrasonic pest deterrent device. The housing is designed to be weather-resistant and can be constructed using one or more plastics. In other embodiments, other materials are utilized. Inside the housing is a circuit board containing a number of standard electronic components including resistors, capacitors, transistors, rectifiers, LEDs, integrated circuits (ICs), and one or more speakers. The ICs include timers, counters, bilateral switches, and flip-flops. The speaker is a device which emits sound waves.

In another embodiment, the specific components and connections between them are different. Therefore, the physical layout and connections between components (as well as the number, type, etc. of components) can vary without departing from the scope of the invention as embodied in the claims.

Additional enhancements can be included in the system, including: a remote control radio device to remotely activate the system and control settings, a directional speaker system to control dispersion of the ultrasonic sound waves, a power source monitor to determine the health of the power source and shut down the system before the source is depleted, etc. Furthermore, the system can be constructed in multiple configurations having varying levels of weather-resistance.

Extending from the housing is a power connector that allows the system to connect to a D/C power source. The connector can attach to a 12 volt D/C battery (such as a car battery), a cigarette lighter plug, a set of D/C power wires, etc.

The present invention provides many benefits over the prior art. By operating on D/C power directly, the system can be quickly and easily installed in a number of locations for which current devices are unsuited, for example: cars, trucks, agricultural equipment, airplanes, gliders, recreational vehicles, trailers, campers, boats, solar homes, hot tubs, sheds, and any other location that has D/C power. Because the system is able to vary the characteristics of the ultrasonic sound waves, the present invention can more effectively deter a wider range of pests. Current systems that do not vary the ultrasonic sounds that they output cause pests to grow accustomed to such sounds and therefore become less effective at deterrence over time. The present invention avoids this pitfall. Deterrence can be further enhanced by varying the timing and intensity of the sounds as well.

### BRIEF DESCRIPTION OF THE DRAWINGS

The aforementioned and other features and objects of the present invention and the manner of attaining them will become more apparent and the invention itself will be best understood by reference to the following descriptions of a preferred embodiment and other embodiments taken in conjunction with the accompanying drawings, wherein:

FIG. 1 illustrates a perspective view of an exemplary embodiment of a direct current ultrasonic pest deterrent system utilizing multiple, varying ultrasonic frequencies being employed in an engine compartment of an automobile.

FIG. 2 illustrates an exemplary embodiment of a circuit diagram displaying novel components of a direct current ultrasonic pest deterrent system utilizing multiple, varying ultrasonic frequencies.

FIG. 3 illustrates a top view of an exemplary embodiment of a direct current ultrasonic pest deterrent system utilizing multiple, varying ultrasonic frequencies employing a remote control device.

### DETAILED DESCRIPTION

A direct current ultrasonic pest deterrent system is effective in removing or otherwise deterring many types of pests. It can be used effectively to deter rodents such as rats and mice as well as snakes, bats, and even some types of insects. Furthermore, the system can deter unwanted cats, dogs, and wild animals as well, depending on the range of frequencies utilized. Because the system is based on a D/C circuit, it can be easily and simply installed in all manner of locations that utilize D/C wiring. For example, it can be deployed in houses, buildings, etc. that utilize a solar electrical system since such systems often run on 12 v D/C. In addition, automobiles utilize 12 v D/C systems and are an area of attraction to rodents and other pests; thus, automobiles are a prime area of installation for the system. Additional locations for deployment of the system include recreational vehicles and campers, hot tubs and other outdoor D/C operated appliances, boats and houseboats, airplanes and gliders, tractors and agricultural machinery, lawn mowers and other lawn equipment, construction vehicles and heavy machinery, and any other location where a 12 v D/C system is available.

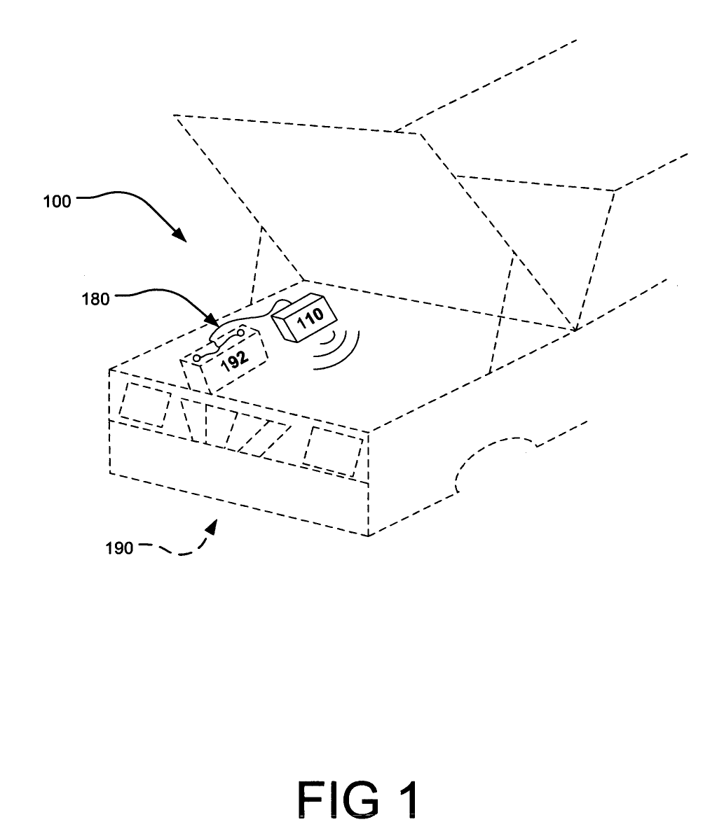

FIG. 1 illustrates a perspective view of an exemplary embodiment of a direct current ultrasonic pest deterrent system 100 utilizing multiple, varying ultrasonic frequencies being employed in an automobile 190 to protect the engine compartment and surrounding areas from rodent infestations and other pests. The primary component of the system shown in FIG. 1 is the system housing 110. The housing 110 is connected to the battery 192 in the engine compartment of the automobile 190 by the power connector 180. Additional embodiments with the direct current ultrasonic pest deterrent system 100 installed in other locations are contemplated.

In the embodiment shown in FIG. 1, the power connector 180 is attached directly to the battery 192 using alligator clips. In another embodiment, the connector 180 taps into D/C power wires. In yet another embodiment, the connector 180 utilizes a cigarette lighter plug to draw power through the D/C outlet in the passenger compartment of the automobile 190.

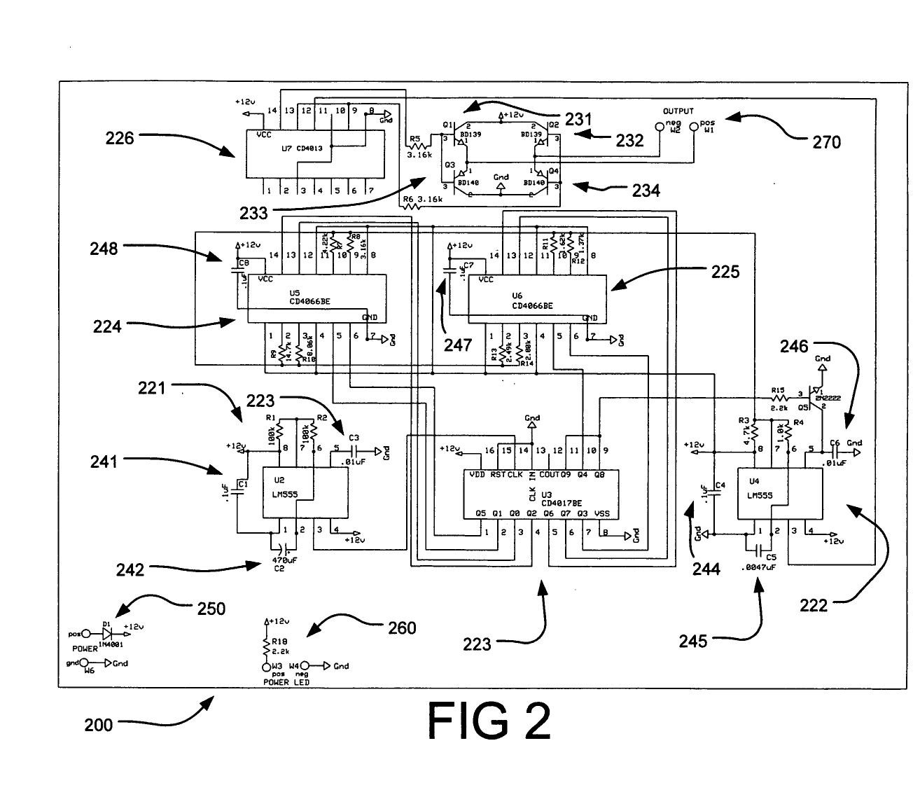

FIG. 2 illustrates an exemplary embodiment of a circuit diagram displaying novel components of a direct current ultrasonic pest deterrent system utilizing multiple, varying ultrasonic frequencies.

The system shown in FIG. 2 can produce sound waves in various ultrasonic frequencies from 25 kilohertz to 42 kilohertz changing every 30 seconds at a noise level of 90 dB or more. The illustrated circuit is capable of producing sound waves with multiple ultrasonic frequencies using random pulsed oscillations. Other embodiments are contemplated that could output different frequencies at varying intervals and noise levels. An additional embodiment is capable of varying frequency, timing, and intensity simultaneously.

The primary components in the embodiment illustrated in FIG. 2 include six ICs 221-226, four transistors 231-234, eight capacitors 241-248, a rectifier 250, an LED 260, a speaker output 270, and a number of resistors. The six ICs illustrated in FIG. 2 are a first 8 pin timer 221, a second 8 pin timer 222, a counter 223, a first bilateral switch 224, a second bilateral switch 225, and a D-type flip-flop 226. It will readily be understood that the various components of this embodiment could be implemented by other equivalent electronic circuits and/or components and that various modifications may be made without departing from the spirit of the invention and the scope of the appended claims.

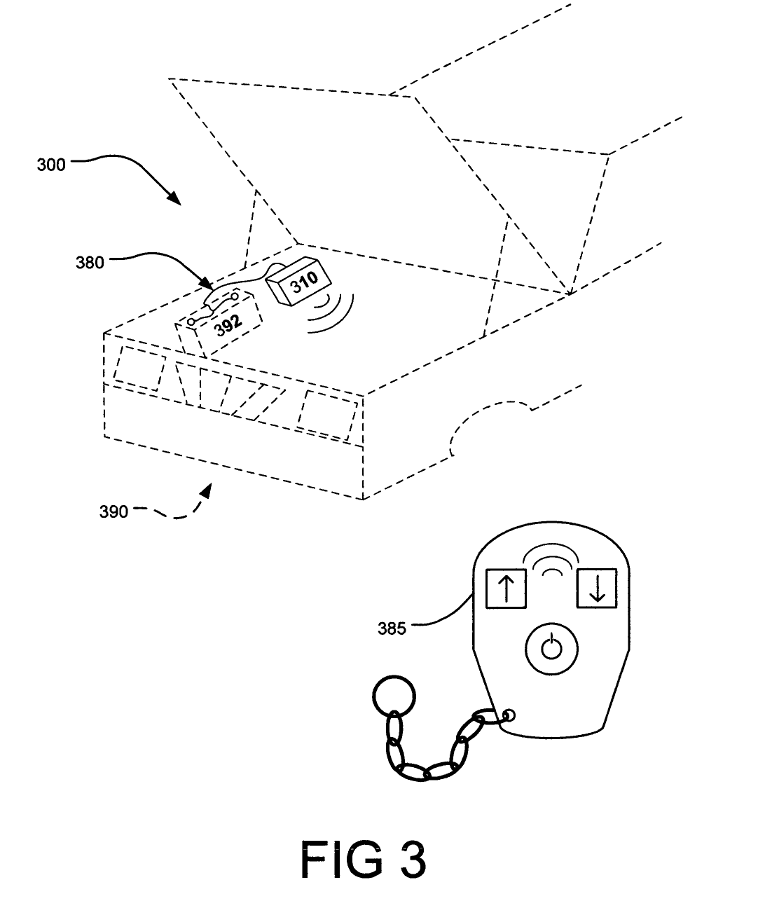

FIG. 3 illustrates a top view of an exemplary embodiment of a direct current ultrasonic pest deterrent system 300 utilizing multiple, varying ultrasonic frequencies employing a remote control device 385. The remote 385 can be used to conveniently and easily turn the system 300 on or off from a distance. If, for example, a pet or other non-noxious creature needs to be in close proximity to the system 300, being able to quickly and easily disable the production of ultrasonic sounds can be a significant advantage over other pest deterrent systems. In another embodiment, the remote 385 can also control the frequency range, timing, and intensity of the sound waves. It is further contemplated that additional functionality can be incorporated into the remote 385.

The housing 310 is connected to the battery 392 in the engine compartment of the automobile 390 by the power connector 380. Additional embodiments with the direct current ultrasonic pest deterrent system 300 installed in other locations are contemplated.

The descriptions above illustrate exemplary components that can make up an exemplary direct current ultrasonic pest deterrent system utilizing multiple, varying ultrasonic frequencies. In addition, the acts of creating the components, integrating them into a system, and activating the system to deter pests are another aspect of this invention.

The above specification, examples and data provide a description of the structure and use of exemplary embodiments of the invention. Since many embodiments of the invention can be made without departing from the spirit and scope of the invention, the invention resides in the claims, including those hereinafter appended and those yet to be authored. Other embodiments are therefore contemplated.

What is claimed is:

1. A direct current ultrasonic pest deterrent system, comprising:
a means for generating ultrasonic sound waves; and
a means for varying the frequency of the sound waves.

2. The system of claim 1, further comprising a means for varying the timing of the sound waves.

3. The system of claim 1, further comprising a means for varying the intensity of the sound waves.

4. The system of claim 2, further comprising a means for varying the intensity of the sound waves.

5. The system of claim 3, having a first timer, a counter, a first bilateral switch, and a speaker.

6. The system of claim 4 having a timer, a counter, a bilateral switch, and a speaker.

7. The system of claim 5 also having a second timer and a second bilateral switch.

8. The system of claim 6 also having a second timer and a second bilateral switch.

9. The system of claim 1 having a first timer and a second timer, a counter, a first bilateral switch and a second bilateral switch, and a speaker.

10. The system of claim 3 having a first timer and a second timer, a counter, a first bilateral switch and a second bilateral switch, and a speaker.

11. The system of claim 9 also having a remote control device.

12. The system of claim 10 also having a remote control device.

13. An apparatus for repelling pests comprising:
a housing having a top, a bottom, and four sides;
at least one speaker;
means for causing the speaker to emit ultrasonic sounds with varying frequencies;
means for connecting said apparatus to a direct current power system; and
the ultrasonic sounds having the effect of repelling pests.

14. The apparatus of claim 13, further comprising a means for varying the timing of the sound waves.

15. The apparatus of claim 13, further comprising a means for varying the intensity of the sound waves.

16. The apparatus of claim 14, further comprising a means for varying the intensity of the sound waves.

17. The apparatus of claim 13 having a first timer and a second timer, a counter, a first bilateral switch and a second bilateral switch.

18. The apparatus of claim 15 having a first timer and a second timer, a counter, a first bilateral switch and a second bilateral switch.

19. The apparatus of claim 16 having a first timer and a second timer, a counter, a first bilateral switch and a second bilateral switch.
